(19) United States
(12) Patent Application Publication
(10) Pub. No.: US 2018/0332689 A1
(43) Pub. Date: Nov. 15, 2018

(54) A LUMINAIRE FOR CONTROLLING A LIGHT OUTPUT OF A LIGHTING MODULE COMPRISING AT LEAST ONE LIGHT SOURCE

(71) Applicant: PHILIPS LIGHTING HOLDING B.V., EINDHOVEN (NL)

(72) Inventors: RAMON ANTOINE WIRO CLOUT, EINDHOVEN (NL); JOCHEN RENAAT VAN GHELUWE, LOMMEL (BE); BARTEL MARINUS VAN DE SLUIS, EINDHOVEN (NL); PHILIP STEVEN NEWTON, WAALRE (NL)

(21) Appl. No.: 15/777,044

(22) PCT Filed: Nov. 16, 2016
(86) PCT No.: PCT/EP2016/077847

§ 371 Date: May 17, 2018

(30) Foreign Application Priority Data
Nov. 26, 2015 (EP) 15196483.0

(51) Int. Cl. H05B 37/02

(52) U.S. Cl. CPC H05B 37/0254

(57) ABSTRACT

A luminaire (100) for controlling a light output of a lighting module (106) comprising at least one light source is disclosed. The luminaire (100) comprises a housing (102) and a plurality of connectors (104, 105) for interfacing with the lighting module (106). Each connector (104, 105) has a position defined by a location relative to the housing (102) and an orientation relative to the gravitational field, wherein at least two connectors (104, 105) have different orientations. The luminaire (100) further comprises a processor (108) for detecting the lighting module (106) at a connector (104) and for accessing information indicative of the position of the connector (104). The processor (108) is further arranged for identifying the lighting module (106) based on a signal received from the lighting module (106), and for controlling 104 the light output of the lighting module (106) based on the identification of the lighting module (106) and the position of the connector (104).

### FIELD OF THE INVENTION

The invention relates to a luminaire for controlling a light output of a lighting module comprising at least one light source. The invention further relates to a lighting module for use in the luminaire. The invention further relates to a method of controlling a light output of a lighting module comprising at least one light source.

### BACKGROUND

Current and future smart lighting devices are already or will be controlled digitally, which provides new control paradigms for such lighting devices. An example of such a smart lighting device is a modular USB luminaire, which comprises sockets arranged for receiving a variety of lamps and sensors. A user may for example remove a lamp, which is arranged for providing task lighting, from a first socket of the luminaire and replace this lamp with a lamp arranged for providing ambient lighting. A second socket of the same luminaire may be arranged for receiving a sensor, such as an occupancy sensor detecting a presence of the user, which provides a sensor signal to a central processing unit of the luminaire that controls a connected lamp accordingly. However, the functionality of such a modular luminaire system currently depends on how each of the connected sensors and/or lamps are configured (or commissioned). This configuration process may be cumbersome for an average user. Thus, there is a need in the art to configure the modules connected to the luminaire automatically.

### SUMMARY OF THE INVENTION

It is an object of the present invention to provide a modular luminaire that configures connected modules automatically. It is a further object of the present invention to provide a modular luminaire that controls connected modules automatically. It is a further object of the present invention to provide a luminaire module arranged for interfacing with the luminaire accordingly.

According to a first aspect of the present invention, the object is achieved by a luminaire for controlling a light output of a lighting module comprising at least one light source, the luminaire comprising:

a housing,

a plurality of connectors for interfacing with the lighting module, which connector has a position defined by a location relative to the housing and an orientation relative to the gravitational field, and wherein at least two connectors have different orientations, and

a processor for detecting the lighting module at a connector, for accessing information indicative of the position of the connector, identifying the lighting module based on a signal received from the lighting module, and for controlling the light output of the lighting module based on the identification of the lighting module and the position of the connector.

By controlling the light output based on the position of the connector where the lighting module is connected to the luminaire, the processor is able to determine how the connected lighting module operates. The position (the location of the connector relative to the housing and the orientation of the connector), and therewith the position of the lighting module, determines how the processor configures and/or controls the lighting module. This provides the advantage that when the lighting module is connected to the luminaire, the light output of the lighting module is controlled based on its position. A user may, for example, connect a lighting module (e.g. an LED lamp) to a connector of a chandelier luminaire, which connector faces upwards. The processor may determine to control the light output of the lighting module according to an ambient light setting, while when the lighting module is connected to a downward facing connector, the processor may determine to control the light output of the lighting module according to a task light setting.

The position of the connector is defined by a location of the connector relative to the housing. The location of the connector (and therewith the location of a connected lighting module) relative to the housing may be determined associated with a unique address of the connector. Each connector may have its own address, and the processor may have access to these addresses. This is advantageous because it allows the processor to determine the location of a connector interfacing with a lighting module.

In an embodiment of the luminaire, the luminaire comprises an orientation sensor for providing an orientation signal indicative of an orientation of the orientation sensor to the processor, and the processor is further arranged for determining the orientation of the connector relative to the housing based on the orientation signal. This is beneficial, because it allows the processor to control the light output of the lighting module based on the orientation (e.g. the tilt) of the luminaire and/or the connector (and therewith the orientation of the lighting module) relative to the gravitational field.

In an embodiment of the luminaire, the orientation sensor is located in the housing of the luminaire. This embodiment may be advantageous when the orientation of the connector is fixed relative to the orientation of the housing, because when the orientation of the connector is fixed relative to the orientation of the housing, the processor is able to determine the orientation of the connector, and therewith the orientation of the lighting module, based on the orientation of the housing.

In an embodiment of the luminaire, the orientation sensor is located in the connector. This embodiment may be advantageous when the orientation of the connector is not fixed relative to the orientation of the housing. The luminaire may, for example, further comprise a connector orientation adjustment element, which connector orientation adjustment element is arranged for adjusting the orientation of the connector relative to the orientation of the housing. This enables the processor to determine the orientation of the connector, and therewith the orientation of the lighting module, based on the signal received from the orientation sensor. In an embodiment of the luminaire, each connector is arranged for interfacing with a sensor module comprising at least one sensor arranged for detecting an environmental condition of the connector or the luminaire, and the processor is arranged for controlling the mode of operation of the sensor module based on the position of the sensor module. This embodiment is advantageous, because it allows the processor to determine how the sensor operates (e.g. how the sensor senses its environment). In a further embodiment, the luminaire further comprises at least one light source (which may be connected to a further connector), and the processor is arranged for controlling the light output of the at least one light source based on the detected environmental condition. This provides the advantage that it enables the processor to control the light setting of the at least one light source.

In an embodiment of the luminaire, the processor is further arranged for controlling the light output of a further lighting module connected to a further connector of the plurality of connectors based on the light output of the lighting module. This allows the processor to, for example, determine the light output of a light emitting module based on the setting of another light emitting module, thereby possibly complementing the light output of the one light emitting module by the light output of the other lighting module.

According to a second aspect of the present invention, the object is achieved by a lighting module for use in the luminaire according to the luminaire of any one of the above-mentioned embodiments, the lighting module comprising:

a second connector for interfacing with one of the plurality of connectors of the luminaire, and

a processor arranged for controlling the light output of the lighting module based on a control signal received from the luminaire.

According to a third aspect of the present invention, the object is achieved by a method of controlling a light output of a lighting module comprising at least one light source, the method comprising the steps of:

detecting the lighting module at a connector of a plurality of connectors, wherein each connector has a position defined by a location relative to a housing of a luminaire and an orientation relative to the gravitational field, and wherein at least two connectors have different orientations,—accessing information indicative of the position of the connector,

identifying the lighting module based on a signal received from the lighting module, and

controlling the light output of the lighting module based on the identification of the lighting module and the position of the connector.

In embodiments of the methods, the method further comprises the step of detecting an orientation of the connector. Detecting the orientation of the connector provides the advantage that it provides specific parameters, which parameters are used to determine the light output of the lighting module.

### BRIEF DESCRIPTION OF THE DRAWINGS

The above, as well as additional objects, features and advantages of the disclosed luminaire, lighting module and methods, will be better understood through the following illustrative and non-limiting detailed description of embodiments of devices and methods, with reference to the appended drawings, in which:

FIG. 1 shows schematically an embodiment of a luminaire according to the invention for controlling a light output of a lighting module;

FIG. 2a shows schematically an embodiment of a luminaire according to the invention comprising a first and a second connector for interfacing with a first and a second lighting module;

FIG. 2b shows schematically an embodiment of a luminaire according to the invention comprising a first, second and third connector for interfacing with a first, second and third lighting module respectively;

FIG. 3a shows schematically an embodiment of a luminaire according to the invention comprising an orientation sensor in the housing of the luminaire;

FIG. 3b shows schematically an embodiment of a luminaire according to the invention comprising a first orientation sensor at a first connector and a second orientation sensor at a second connector; and

FIG. 4 shows schematically an embodiment of an orientation sensor.

All the figures are schematic, not necessarily to scale, and generally only show parts which are necessary in order to elucidate the invention, wherein other parts may be omitted or merely suggested.

### DETAILED DESCRIPTION OF EMBODIMENTS

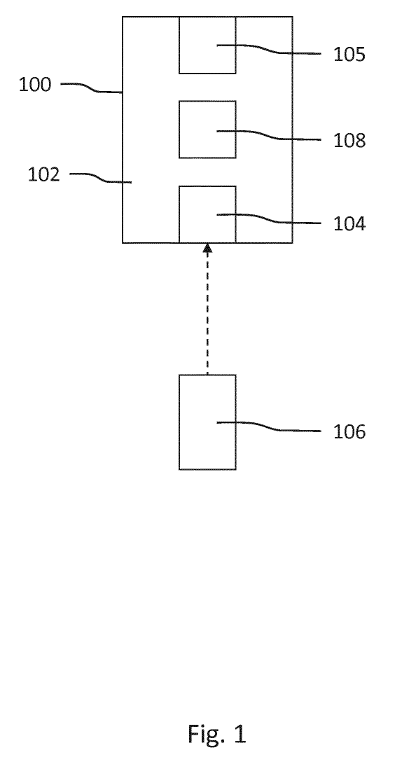

FIG. 1 shows schematically an embodiment of a luminaire 100 according to the invention for controlling a light output of a lighting module 106. The luminaire 100 comprises a housing 102 and a plurality of connectors 104 for interfacing with the lighting module 106. Each of the connectors 104, 105 has a position relative to the housing, which position may be defined by a fixed location and an orientation relative to the gravitational field. The orientation may be detected by an orientation sensor. The luminaire 100 further comprises a processor 108 (e.g. a microcontroller, a microchip, circuitry, etc.) for detecting the presence of the lighting module 106 at a connector 104 of the plurality of connectors 104, 105 and for accessing information indicative of the position of the connector 104 (for example by receiving the information from an orientation sensor, accessing a memory storing a look-up table storing information about one or more connectors and their respective positions, etc.). The processor 108 is further arranged for identifying the lighting module 106 based on a signal received from the lighting module 106, and for controlling the light output of the detected lighting module 106 based on the identification of the lighting module 106 and the position of the respective connector 104. This enables the processor 108 to, for example, determine how to configure and/or control the lighting module 106, or how to interpret data received from the lighting module 106.

Each connector 104, 105 is arranged for interfacing with a lighting module 106. This interface (i.e. a connection) allows either one-directional or bidirectional data communication. This allows the processor 108 to identify, detect, control and/or configure the lighting module 106. The lighting module 106 may, for example, be a USB module and the connector 104, 105 may be a USB socket for receiving the lighting module 106. A connected USB module may communicate, for example, its idVendor and idProduct (which are standardized USB descriptors) to the processor 108, thereby allowing the processor 108 to identify the lighting module 106. The USB module may further communicate its device related properties (such as light emission properties, dimming properties, light colour, beam shape, sensing properties, etc.). The luminaire 100 may further comprise a memory for storing the properties of the identified lighting module 106.

The connectors 104, 105, which may be comprised in the housing 102 or may be located outside the housing 102, may be any connector 104, 105 arranged for interfacing with a lighting module 106. The connectors 104, 105 may have a fixed position relative to the housing 102, or the connectors 104, 105 may have an adjustable position relative to the housing 102. The connectors 104, 105 are arranged for interfacing with the lighting module 106, which lighting module 106 may be connected to a connector 104, 105 with a fixed position relative to the housing 102. By connecting the lighting module 106 to a connector 104, 105 with a fixed position relative to the housing 102, the processor 108 is able to determine the position of the lighting module 106 based on the position of the connector 104. The connector 104, 105 may, for example, be a socket (e.g. a screw socket (E14, E26, E27, etc.), a bayonet socket, a USB socket, a power over Ethernet socket, etc.) or a plug (e.g. a screw plug (E14, E26, E27, etc.), a bayonet plug, a USB plug, a power over Ethernet plug, etc.), but it may also be a connector 104, 105 that is arranged for connecting with the lighting module 106 via any other mechanical connection (for example a magnetic connection).

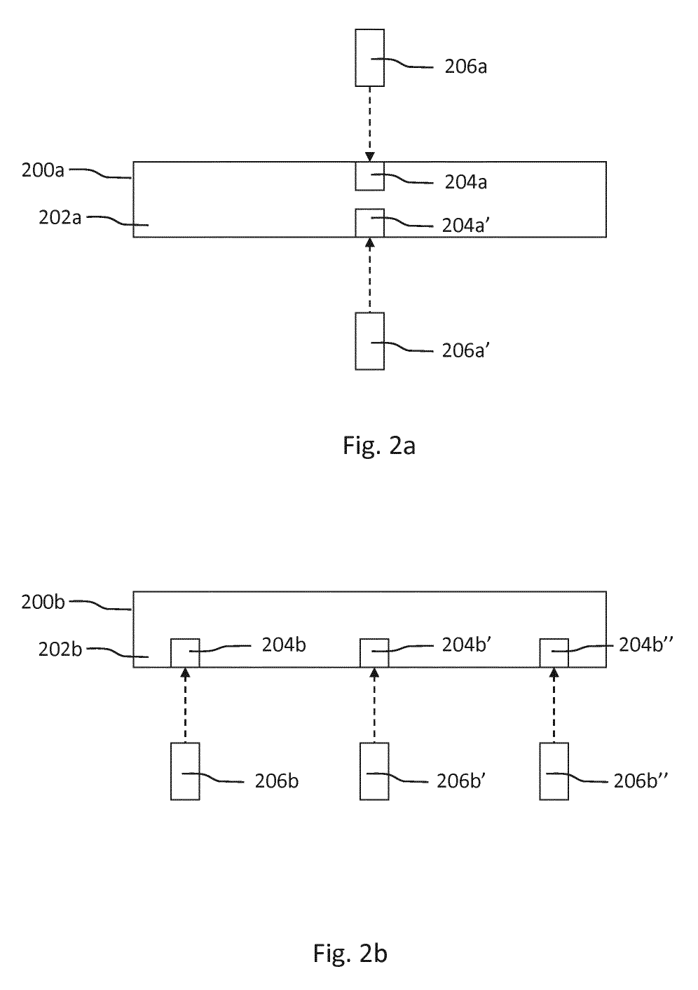

Each connector 104, 105 has a position relative to the housing 102. The position of a connector 104, 105 (and therewith the location of a connected lighting module 106) may be defined by a location of the connector 104, 105 relative to the housing 102. Each connector 104, 105 may be associated with a unique address, and the processor 108 may have access to these addresses, allowing the processor 108 to determine which connector 104, 105 is interfacing with which lighting module 106. FIG. 2b shows an example of a luminaire 200b comprising connectors 206b, 206b′ and 206b″ with positions are defined by locations of the connectors 204b, 204b′, 204b″relative to the housing 202b. The luminaire 200b comprises a first connector 206b with a first location (left) relative to the housing 202b, which is associated with a first address Al. The luminaire 200b further comprises a second connector 206b′ with a second location (center) relative to the housing 202b, which is associated with a second address A2. The luminaire 200b further comprises a third connector 206b″ with a third location (right) relative to the housing 202b, which is associated with a third address A3. In this example, the processor (not shown) may have access to a memory (not shown) which stores the locations of the connectors 204b, 204b′, 204b″, for example as unique addresses A1, A2, and A3 which are associated with their locations. This allows the processor 108 to control the light output of a connected lighting module 206b, 206b′, 206b″based on the location of the lighting module 206b, 206b′, 206b″.

The position of the connector 104, 105 may be represented by its orientation relative to the housing (which housing has an orientation relative to the gravitational field). The luminaire may, for example, have multiple connectors which each have their own orientation relative to the housing. FIG. 2a shows an example of such a luminaire 200a. The luminaire 200a in FIG. 2a comprises a first connector 204a with a first orientation (up) relative to the housing 202a and a second connector 204a′ with a second orientation (down) relative to the housing 202a of the luminaire 200a. In this example, the processor (not shown) may have access to a memory (not shown) which stores the orientations of the connectors 204a, 204a′. This allows the processor to control the light output of a connected lighting module 206a, 206a′ based on the orientation of the lighting module 206a, 206a′. In an embodiment wherein the position is determined by both the location and the orientation of the connector 204a, 204a′, the processor is able to control the light output of a connected lighting module 206a, 206a′ based on both the orientation and the location of the lighting module 206a, 206a′.

The processor 108 is arranged for identifying the lighting module 106 based on a signal received from the lighting module 106. Upon connecting the lighting module 106 to the connector 104, the connector 104 and the lighting module 106 interface, thereby allowing the processor 108 to receive a signal which identifies the lighting module 106.

The processor 108 is further arranged for controlling the light output of the lighting module 106 based on the identification of the lighting module 106 and the position of the connector 104 (and therewith the orientation of the lighting module 106). A lighting control signal is communicated to the lighting module 106, allowing the lighting module 106 to set its light output to the light output determined by the processor 108. This allows the processor 108 to configure/control the lighting module 106. FIG. 2a shows schematically an embodiment of a luminaire 200a according to the invention comprising a first connector 204a and a second connector 204a′ for interfacing with a first lighting module 206a and a second lighting module 206a′. The first connector 204a is located at the top side of housing 202a of the luminaire 200a, and it is oriented upwards. The second connector 204a′ is located at the bottom side of the housing 202a of the luminaire 200a, and it is oriented downwards. In the exemplary embodiment of FIG. 2a, the positions (locations and/or orientations) of the connectors 204a, 204a′ are fixed relative to the housing 202a. The next examples illustrate how the processor (not shown) may control the light output of the first lighting module 206a and the second lighting module 206a′ based on their orientation relative to the housing 202a.

In a first example, the luminaire 200a may be a pendant lamp hanging on a ceiling. A user may connect the first lighting module 206a to the first connector 204a and the second lighting module 206a′ to the second connector 204a′. In this example, the first and second lighting modules 206a, 206a′ comprise one or more light sources arranged for emitting light. Based on the orientation of the lighting modules 206a, 206a′ relative to the housing 202a, the processor determines the light output of the lighting modules 206a, 206a′. The processor may, for example, determine to control the light output of the first lighting module 206a (oriented upwards) according to an ambient light setting (e.g. a warm yellow colour to illuminate the ceiling) and to control the light output of the second lighting module 206a′ (oriented downwards) according to a task light setting (e.g. a cool white colour to illuminate the surface, e.g. a table, underneath the pendant lamp).

FIG. 2b shows schematically an embodiment of a luminaire 200b according to the invention comprising a first connector 204b, a second connector 204b′ and a third connector 204b″ for interfacing with a first lighting module 206b, a second lighting module 206b′ and a third lighting module 206b″. The first connector 204b is located at the left side of housing 202b of the luminaire 200b, and it is oriented downwards. The second connector 204b′ is located at the center of the housing 202b of the luminaire 200b, and it is also oriented downwards. The third connector 204b″ is located at the right side of the housing 202b of the luminaire 200b, and it is also oriented downwards. In the exemplary embodiment of FIG. 2b, the positions (location and/or orientation) of the connectors 204b, 204b′, 204b″ are fixed relative to the housing 202b. The luminaire 200b may, for example be a troffer installed in the ceiling. A user may connect the first lighting module 206b, the second lighting module 206b′ and the third lighting module 206b′ to the first, second and third connectors 204b, 204b′, 204b″ respectively. In this example, the first, second and third lighting modules 206b, 206b′, 206b″ may comprise one or more light sources arranged for emitting light. Based on the location of the lighting modules 206b, 206b′, 206b″ relative to the housing 202b, the processor determines the light output of the lighting modules 206b, 206b′, 206b″. The processor may, for example, determine to set the light output of the first lighting module 206b to a red light setting and to set the light output of the third lighting module 206b″ to a yellow light setting based on their location relative to the housing 202b. In order to create a consistent light effect (e.g. a gradually changing colour from red to yellow), the processor may determine to set the light output of the second lighting module 206b′ to an orange light setting based on its location relative to the housing 202b.

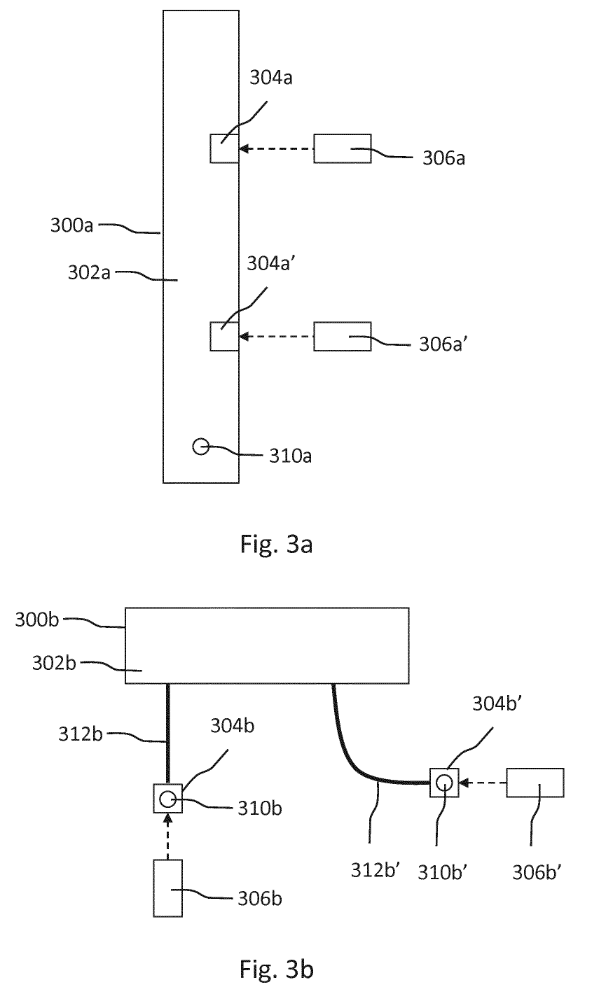

The luminaire 100 may further comprise an orientation sensor for providing an orientation signal. This allows the processor 108 to determine the orientation of the connector 104, 105 relative to the housing 102 based on the orientation signal. The next examples, as illustrated in FIGS. 3a and 3b, explain how the processor may determine the orientation of the lighting module based on the orientation signal.

In a first example, as illustrated in FIG. 3a, the orientation sensor 310a is located at the housing 302a of the luminaire 300a. This is beneficial if the connectors 304a, 304a′ have a fixed orientation relative to the housing 302a. The orientation sensor 310a may be arranged for detecting an orientation and/or a location of the luminaire. The orientation sensor 310a may for example detect that the luminaire 300a is installed in a vertical orientation and the processor may control the light output of the lighting modules 306a, 306a′ based on this detection.

In a second example, as illustrated in FIG. 3b, the orientation sensors 310b, 310b ′ are located at the connectors 304b, 304b′ of the luminaire 300b. This is advantageous when the orientation of the connector is not fixed relative to the orientation of the housing 302b. The luminaire 300b may, for example, further comprise a first connector orientation adjustment element 312b and a second connector orientation adjustment element 312b′, which connector orientation adjustment elements 312b, 312b′ are arranged for adjusting the orientation of the connectors 304b, 304b′ relative to the orientation of the housing 302b. The connector orientation adjustment elements 312b, 312b′ (e.g. flexible/bendable rods, rods comprising one or more moveable joints, or any other mechanically operable adjustable means) couple the connectors 304b, 304b′ to the housing 302b and allow a user or the processor to change the location and/or the orientation of the connectors 304b, 304b′. Orientation sensor 310b may for example detect that the connector 304b is oriented downwards, and orientation sensor 310b ′ may for example detect that the connector 304b′ is oriented horizontally. The orientation sensors 310b, 310b ′ may be arranged for generating the orientation signals based on the detected orientation and/or location, and for communicating the orientation signals to the processor 108, which determines the light output of the lighting modules 306b, 306b′ based on the orientation signals.

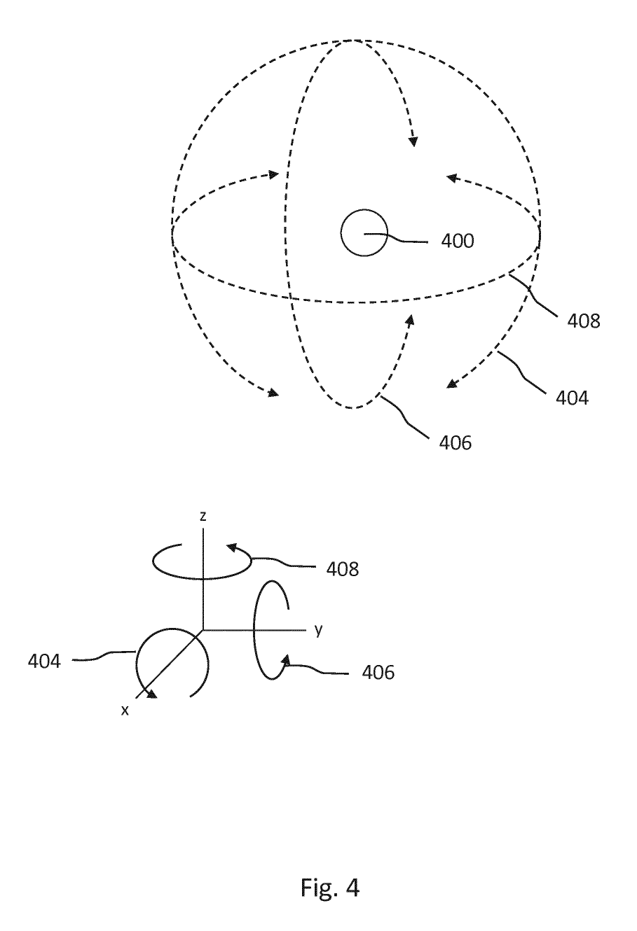

FIG. 4 shows schematically an embodiment of an orientation sensor for detecting an orientation relative to the gravitational field. The orientation sensor 400 may be arranged for detecting an orientation of the luminaire 100 or a connector 104, 105 relative to the gravitational field. The orientation sensor 400 may comprise one or more accelerometers, one or more gyroscopes, one or more magnetometers, one or more tilt sensors, etc. in order to determine the orientation of the luminaire 100. The orientation of the luminaire 100 may be defined by the roll 404, pitch 406 and yaw 408 of the luminaire 100 around the X, Y and Z axes respectively. Upon detecting the orientation of the luminaire 100, the orientation sensor 400 may generate an orientation signal in order to communicate the orientation to the processor 108. The processor 108 may determine the orientation of the lighting module 106 based on the orientation signal and control the light output of the lighting module based on the orientation 400.

Each connector 104, 105 is arranged for interfacing with a lighting module comprising at least one light source (e.g. an LED light source, an incandescent light source, a fluorescent light source, etc.). The processor 108 is arranged for controlling the light output of the at least one light source based on the position (the location relative to the housing 102 and/or the orientation) of the lighting module. For example, an upward facing light emitting module may emit coloured light at a low intensity, while a downward facing light emitting module may emit white light at a high intensity.

Additionally or alternatively, each connector 104, 105may be arranged for interfacing with a sensor module comprising at least one sensor (e.g. a temperature sensor, a light sensor, a camera, etc.) arranged for detecting an environmental condition of the connector 104, 105 or the luminaire 100, and the processor 108 may be arranged for setting the mode of operation of the sensor module based on the position of the sensor module. The sensor module may, for example, comprise a audio sensor. Depending on the position (location and orientation) of the audio sensor, the processor 108 may determine to set a first mode of operation or a second mode of operation. In the first mode of operation, the audio sensor may, for example, be set to a high sensitivity, while in the second mode of operation, the audio sensor may be set to a low sensitivity. This may be advantageous if the audio sensor is arranged for receiving voice input. For example, an upward facing audio sensor may require a louder noise, and therefore require a higher sensitivity, while a downward facing audio sensor may require a less loud noise, and therefore require a lower sensitivity.

The luminaire 100 comprises a plurality of connectors 104, 105. In an embodiment, a first connector may be interfacing with a light emitting module, and a second connector may be interfacing with a sensor module. The processor 108 may determine the light output of the light emitting module based on sensor information from the sensor module. The sensor module may for example comprise an occupancy sensor arranged for detecting the presence of a plurality of people. The processor 108 may determine to control the light emitting module according to a first light output, e.g. a task lighting setting, when one person is detected, or to a light output, e.g. an ambient light setting, when a plurality of persons are detected, or to a ‘low energy’ mode when no people are detected. Alternatively, the processor 108 may determine the mode of operation of the sensor module based on a current light output. The light emitting module may for example comprise one or more light sources for providing cool bright lighting and, alternatively, for providing less bright coloured lighting. The processor 108 may determine to set the sensor module, which for example comprises a camera to detect the presence of objects and/or people, to a first mode of operation, e.g. a low sensitivity when the light emitting module emits cool bright lighting, or to a second mode of operation, e.g. a high sensitivity when the light emitting module emits less bright coloured lighting.

The luminaire 100 may be further arranged for receiving control commands from a further device, such as a user interface device (e.g. a smartphone, a smart watch, a tablet pc, etc.). Such a control command may, for example, comprise instructions for applying a specific light setting to the luminaire 100. The light setting, for example a rainbow light effect, may be selected by a user operating the user interface device. The processor 108 of the luminaire 100 may be further arranged for setting the mode of operation further based on the user input. Based on, for example, the selection of the rainbow effect (red, orange, yellow, green, blue, purple), the processor 108 may determine to control the light output of a first lighting module 106 connected to a first connector to emit light according to a first colour of the rainbow, and to control the light output of five other connectors accordingly such that they emit light according to the other five colours of the rainbow. Such a light effect may also be a dynamic light effect (i.e. a light effect that changes hue, saturation and/or brightness over time).

It should be noted that the above-mentioned embodiments illustrate rather than limit the invention, and that those skilled in the art will be able to design many alternative embodiments without departing from the scope of the appended claims.

In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer or processing unit. In the device claim enumerating several means, several of these means may be embodied by one and the same item of hardware. The mere fact that certain measures are recited in mutually different dependent claims does not indicate that a combination of these measures cannot be used to advantage.

1. A luminaire for controlling a light output of a lighting module comprising at least one light source, the luminaire comprising:
a housing,
a plurality of connectors for interfacing with lighting modules wherein each connector has a position defined by a location relative to the housing and an orientation relative to the gravitational field, and wherein at least two connectors have different orientations, and
a processor for detecting the lighting module at a connector, for accessing information indicative of the position of the connector, for identifying the lighting module based on a signal received from the lighting module, and for controlling the light output of the lighting module based on the identification of the lighting module and the position of the connector.

2. The luminaire of claim 1, wherein the luminaire comprises an orientation sensor for providing an orientation signal indicative of the orientation of the orientation sensor to the processor, and wherein the processor is further arranged for determining the orientation of the connector based on the orientation signal.

3. The luminaire of claim 2, wherein the orientation sensor is located in the housing of the luminaire.

4. The luminaire of claim 3, wherein the orientation of the connector is fixed relative to the orientation of the housing, and wherein the processor is further arranged for determining the orientation of the connector based on the orientation of the housing.

5. The luminaire of claim 2, wherein the orientation sensor is located in the connector.

6. The luminaire of claim 5, wherein the luminaire further comprises a connector orientation adjustment element, which connector orientation adjustment element is arranged for adjusting the orientation of the connector relative to the orientation of the housing.

7. The luminaire of claim 1, wherein the processor is further arranged for controlling the light output of a further lighting module connected to a further connector of the plurality of connectors based on the light output of the lighting module.

8. The luminaire of claim 1 further comprising the lighting module, the lighting module comprising:
a second connector for interfacing with one of the plurality of connectors of the luminaire, and
a second processor arranged for controlling the light output of the lighting module based on a control signal received from the luminaire.

9. A method of controlling a light output of a lighting module comprising at least one light source, the method comprising the steps of:
detecting the lighting module at a connector of a plurality of connectors wherein each connector has a position defined by a location relative to a housing of a luminaire and an orientation relative to the gravitational field, and wherein at least two connectors have different orientations,
accessing information indicative of the position of the connector,
identifying the lighting module based on a signal received from the lighting module, and
controlling the light output of the lighting module based on the identification of the lighting module and the position of the connector.

10. The method of claim 9, further comprising the step of detecting the orientation of the connector.
